(19) United States
(12) Patent Application Publication
(10) Pub. No.: US 2013/0250591 A1
(43) Pub. Date: Sep. 26, 2013

(54) APPARATUS AND METHOD FOR ASSISTING HUMAN BEINGS IN THE DOMESTIC ENVIRONMENT

(71) Applicants: Benjamin Petri, Stuttgart (DE); Igor Tchoudovski, Waiblingen (DE)

(72) Inventors: Benjamin Petri, Stuttgart (DE); Igor Tchoudovski, Waiblingen (DE)

(73) Assignee: Robert Bosch GmbH, Stuttgart (DE)

(21) Appl. No.: 13/616,554

(22) Filed: Sep. 14, 2012

(30) Foreign Application Priority Data
Sep. 27, 2011 (DE) 10 2011 083 488.5

(51) Int. Cl. F21V 14/02

(52) U.S. Cl. CPC F21V 14/02
USPC 362/418

(57) ABSTRACT

An apparatus for assisting human beings in the domestic environment includes a light source configured to produce a positionable luminous object. The apparatus is configured to project the luminous object onto different objects in the domestic environment. The luminous object may be a light marker to highlight articles or to present a pool of light on a projection area for instructions. The apparatus is used for structuring a daily routine with events, such as a telephone call, being taken into account. A method involves determining a domestic environment and proceeding with a domestic situation according to the daily routine.

This application claims priority under 35 U.S.C. §119 to patent application no. DE 10 2011 083 488.5, filed on Sep. 27, 2011 in Germany, the disclosure of which is incorporated herein by reference in its entirety.

### BACKGROUND

The present disclosure relates to an apparatus and a method for assisting human beings in the domestic environment.

Older human beings, in particular, can be assisted by technical systems which facilitate orientation at home and accomplishment of the daily routine for them. Thus, US 20100231506 A1 discloses an aid for the operator control of articles in a domestic environment by virtue of action instructions being projected onto a projection area. The action instructions may be operator control instructions, recipes or depicted hands belonging to a demonstration user. It is also possible to use advice on a projection area to indicate use of an article which is advantageously in proximity to the projection area. The latter can be encouraged by passive devices on the article, such as retroreflective elements or high contrasts, if the user responds thereto.

WO 2009063114 A1 describes tracking and finding of articles in a domestic environment by means of RFID for visually impaired people.

A system according to US 20050270158 A1 can be used to track people but also articles by means of RFID, particularly whether said people and/or articles are inside or outside a defined local area, for example a house, a kindergarten or a school.

### SUMMARY

The present disclosure provides an apparatus and a method for assisting human beings in the domestic environment. In contrast to the prior art, the attention of a user is steered directly to an object in the domestic environment by producing a positionable luminous object and projecting it onto the object.

According to the disclosure, the daily routine of a human being can be structured and provided with a degree of regularity.

An article to be used is indicated to a user by marking the article with a point of light or a pool of light.

Mislaid articles can be located and found.

### BRIEF DESCRIPTION OF THE DRAWINGS

The present disclosure is explained in more detail below with reference to the exemplary embodiments indicated in the schematic figures of the drawings.

FIG. 1 shows a schematic illustration of a domestic environment with an apparatus for assisting human beings in the domestic environment according to an embodiment of the present disclosure.

FIG. 2 shows a flowchart of the method for assisting human beings in the domestic environment according to an embodiment of the present disclosure.

The accompanying drawings are intended to convey further understanding of the embodiments of the disclosure. They illustrate embodiments and are used in connection with the description to explain principles and concepts of the disclosure. Other embodiments and many of the cited advantages are revealed in light of the drawings. The elements of the drawings are not necessarily shown true to scale with respect to one another.

### DETAILED DESCRIPTION

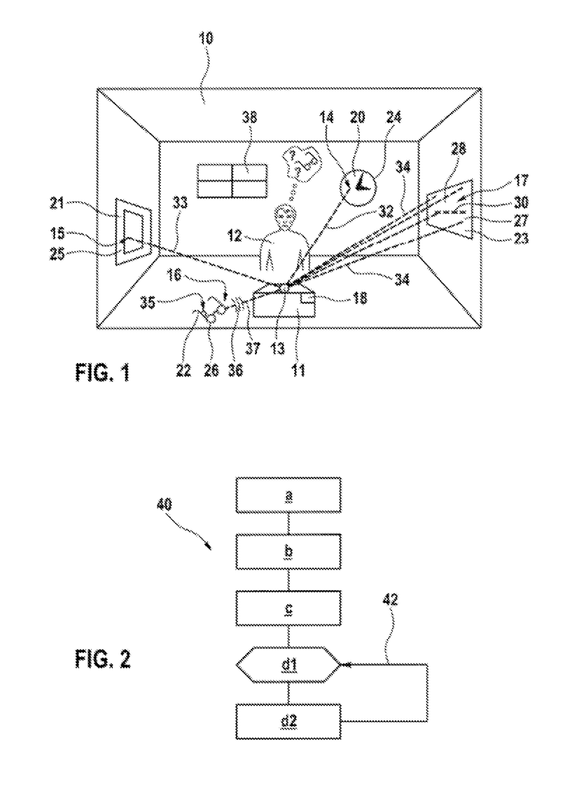

FIG. 1 shows a domestic environment 10 with an apparatus 11 for assisting human beings 12 in the domestic environment 10 according to an embodiment of the present disclosure. The apparatus 10 for assisting human beings in the domestic environment 10 has a light source 13 for producing a positionable luminous object 14, 15, 16, 17 and a controller 18. The controller 18 controls the apparatus 11 and likewise the method according to the disclosure. The apparatus 11 is designed to project the luminous object 14, 15, 16, 17 onto different objects 20, 21, 22, 23 in the domestic environment 10. In this context, one or more objects 20, 21, 22, 23 can be marked with a luminous object 14, 15, 16, 17 at the same time. In this example, the objects 20, 21, 22, 23 are a clock 24, a television 25, a pair of glasses 26 and a projection area 27.

The light source 13 may have a spotlight, a laser and/or a projector. The luminous objects 14, 15, 16 are light markers on the articles clock 24, television 25 and glasses 26 in the domestic environment 10.

The luminous object 17 is a pool of light 28 on the projection area 27 which is produced using a projector from the light source 13. The pool of light 28 can display both a piece of text information 30 and images.

A further possibility, which is not shown, is to illuminate a living area, for example an area of a room such as a dining area or sofa area, and in this way to mark it with a luminous object.

In this example, the articles clock 24, television 25 and projection area 27 in the domestic environment 10 are at fixed locations. The light source 13 can be set up for these articles such that beams of light 32, 33, 34 at fixed locations produce the luminous objects 14, 15, 17. By contrast, the glasses 26 are not at a fixed location. The glasses 26 have a locating unit which, in the present example, is equipped as an RFID tag 35 which can emit radiowaves 36 that can be used by the apparatus 11 to locate the RFID tag 35 or the glasses 26. To this end, the apparatus 11 is equipped with an RFID locating device. Following such location, a variably positionable beam of light 37 can produce the light marker, luminous object 16.

According to the present disclosure, human beings 12 are assisted in the domestic environment 10 by means of the apparatus 11, which is installed in the domestic environment 10, a house or an apartment or a room or is simply set up as a mobile version. Preferably, each room contains an appliance such as apparatus 11, for example under the ceiling or on a table, which can mark/highlight articles or living areas in the respective room by illumination. This draws the attention of the inhabitant to tasks that need to be accomplished. Lost articles could also be located in this manner.

According to one alternative embodiment of the disclosure, the apparatus can move itself, in a similar manner to a robot vacuum cleaner.

According to a further embodiment of the disclosure, the apparatus is able not only to determine a position of an object but additionally to mark a path to the object, e.g. if the glasses are in a different room.

According to another embodiment of the disclosure, as an alternative to beams of light such as the beams of light 32, 33, 34, 37, which are directed onto objects and produce luminous objects at that location, LED stickers are put on the respective object. The luminous LEDs then form the luminous objects. Preferably, the stickers each contain a power supply for the LEDs and can be actuated wirelessly.

The pool of light 28 on the projection area 27 allows the use of augmented reality, with all open surfaces in the apartment being able to be used to present the augmented reality. By way of example, the content of a refrigerator can be visually displayed on the surface of the refrigerator and missing foodstuffs can be highlighted at the same time. The augmented reality thereby becomes accessible not only to the user but also to all other people in the room. The use of such augmented reality turns many open surfaces into information media for the user. By way of example, an Outlook calendar, a clock, photos can be projected onto different walls at the times at which the information can be used by the user. Installed video cameras and/or motion sensors allow the projected areas to be used for the input of information, e.g. by means of a laser keyboard, selection panel. Further input options may be a separate keyboard or else a telephone call.

FIG. 2 shows a flowchart 40 of the method for assisting human beings in the domestic environment based on an embodiment of the present disclosure. The method is explained using the example of the domestic environment shown in FIG. 1, wherein the controller 18 of the apparatus 11 controls the method flow and is of appropriate design. The method for assisting human beings in the domestic environment starts with method step a) a domestic environment is defined with associated objects from the environment. This method step is used to define what articles or living areas from the domestic environment are involved in the method. In the example from FIG. 1, the articles clock 24, television 25, glasses 26 and projection area 27 are defined as elements of the domestic environment. By contrast, a window 38 in the domestic environment is not involved in the domestic environment in this example, even though that would be possible and would sometimes make sense.

In method step b), the domestic environment is now learned. This method step is used by the light source 13 to learn positions of the articles at fixed locations, clock 24, television 25 and projection area 27, in the domestic environment and to stipulate how these articles are marked. In addition, the RFID identifier of the glasses 26 is learned such that the apparatus 11 can locate and mark the glasses 26.

The learning of the domestic environment preferably comprises the detection and identification of suitable projection areas.

In an alternative embodiment, which is not shown, the learning of the domestic environment may comprise the detection of articles by means of image recognition. This may also include the recognition of articles with an RFID identifier. The apparatus 11 first of all measures the apartment in order to determine the precise geometry. The surfaces are then successively highlighted, illuminated, and the user is asked whether the surface is suitable for presenting information. Next, information elements are assigned to the surfaces.

Method step c) is then used to define a domestic situation with tasks and associated conditions under which tasks are associated with objects in the domestic environment. One condition comprises a time being reached. This allows a daily routine to be structured. By way of example, in the morning the toothbrush is highlighted, at 8:00 the base station of a telemedical system is marked for the purpose of checking medical values, at 11:00 the telephone is marked in order to call the doctor, and at 18:00 a medication packet on the table is marked.

One condition also comprises an event occurring. Thus, an incoming telephone call can involve the telephone being marked with a light marker. Further events are a new piece of medical information arriving and an incoming message.

It is likewise possible for the task to be an action and for the instruction for the action to be projected onto a projection area 27 by means of the pool of light. To this end, the conditions for the display are defined.

One task in the domestic situation is searching for a mislaid article in the domestic environment. This requires an input capability for determining the mislaid article, for example using a laser keyboard on the projection area 27 or using another input unit. The input unit may also be connected to the telemedical base station or linked thereto.

Method step c) then completes the preparation of the apparatus 11, and method step d) involves the domestic situation proceeding, with the occurrence of a condition—d1) in flowchart 40—involving indication—d2) in flowchart 40—of the associated task by virtue of the production of a luminous object on at least one of the associated objects. Method substeps d1) and d2) take place repeatedly, identified by the loop 42. Hence, a regular daily routine is undergone and repeated.

An occurrence of one condition—d1) is also the starting of a search for an object or display of a piece of information. This may involve the use of voice recognition in order to start the search for the object/display of information or else for other user inputs.

Examples of a long-term task are the display of a photo gallery or of a calendar.

Although the present disclosure has been described fully above with reference to preferred exemplary embodiments, it is not limited thereto but rather can be modified in a wide variety of ways.

What is claimed is:

1. An apparatus for assisting human beings in the domestic environment, comprising:
a light source configured to produce a positionable luminous object; and
a controller,
wherein the apparatus is configured to project the luminous object onto different objects in the domestic environment.

2. The apparatus according to claim 1, wherein the light source has one or more of a spotlight, a laser and a projector.

3. The apparatus according to claim 1, wherein the luminous object is a light marker and the objects in the domestic environment are one or more of articles and living areas in the domestic environment.

4. The apparatus according to claim 3, wherein the articles comprise mobile everyday articles with an RFID tag.

5. The apparatus according to claim 1, wherein the luminous object is a pool of light and the objects in the domestic environment have a projection area.

6. A method for assisting human beings in a domestic environment, comprising:
defining a domestic environment with associated objects from the domestic environment;
learning the domestic environment;
defining a domestic situation with tasks and associated conditions under which the tasks are associated with the objects from the domestic environment; and
proceeding with the domestic situation with the occurrence of at least one of the associated conditions, the domestic situation proceeding by indicating the associated task by producing a luminous object on at least one of the associated objects.

7. The method according to claim 6, wherein the luminous object is produced using a light source having one or more of a spotlight, a laser, and a projector.

8. The method according to claim 6, wherein the luminous object is a light marker and the objects in the domestic environment are one or more of articles and living areas in the domestic environment.

9. The method according to claim 6, wherein the learning of the domestic environment comprises one or more of the learning of articles and the learning of positions.

10. The method according to claim 6, wherein the learning of the domestic environment comprises the detection of articles by use of one or more of image recognition and an RFID tag.

11. The method according to claim 6, wherein the luminous object is a pool of light and the objects in the domestic environment have a projection area.

12. The method according to claim 11, wherein the learning of the domestic environment comprises the detection and identification of suitable projection areas.

13. The method according to claim 11, wherein the task is an action and an instruction for the action is projected onto the projection area by use of the pool of light.

14. The method according to claim 6, wherein the condition comprises a time being reached or an event occurring.

15. The method according to claim 6, wherein the task is searching for an article in the domestic environment.
